(19) United States
(12) Patent Application Publication
(10) Pub. No.: US 2017/0346309 A1
(43) Pub. Date: Nov. 30, 2017

(54) RECHARGEABLE BATTERY AND CHARGING METHOD THEREOF

(71) Applicant: MSI COMPUTER (SHENZHEN) CO.,LTD., Shenzhen City (CN)

(72) Inventors: Yu-Szu LEE, Taipei City (TW); Ching-Yu HO, New Taipei City (TW); Chung-Wei CHANG, Yilan County (TW); Chia-Hua TSAI, New Taipei City (TW)

(73) Assignee: MSI COMPUTER (SHENZHEN) CO.,LTD., Shenzhen City (CN)

(21) Appl. No.: 15/239,478

(22) Filed: Aug. 17, 2016

(30) Foreign Application Priority Data
May 30, 2016 (TW) 105116837

(51) Int. Cl. H02J 7/00

(52) U.S. Cl. CPC H02J 7/0018; H02J 7/0021

(57) ABSTRACT

A rechargeable battery includes power storage modules, a charging module and a control module. The charging module is electrically connected to the power storage modules. The control module is electrically connected to the power storage modules. The charging module is configured to selectively charge the power storage modules through a plurality of charging paths. Each power storage module corresponds to one of the charging paths. The control module is configured to command the charging module to charge at least one of the power storage modules according to the SoC of each power storage module.

### CROSS-REFERENCE TO RELATED APPLICATIONS

This non-provisional application claims priority under 35 U.S.C. §119(a) on Patent Application No(s). 105116837 filed in Taiwan, R.O.C. on May 30, 2016, the entire contents of which are hereby incorporated by reference.

### BACKGROUND

### Technical Field

The disclosure is related to a rechargeable battery and a charging method thereof, more particularly to a rechargeable battery with multiple power storage modules and a charging method thereof.

### Related Art

The battery or battery pack in a modern electronic product usually has multiple power storage modules for the enhancement of battery power supply capacity or battery lifetime. However, in fact, power storage modules in a battery may at least in part have different power supply capacities, so these power storage modules may at least in part have different states of charge at the same time point. In the duration of charging a battery or a battery pack, all the storage modules are subjected to the same charging mode or manner while not every storage module's real state would be considered. Because of non-ideal facts in practice or the user's habit, the battery or battery pack may not be fully charged. Certain one of the storage modules may always be the lowest due to the different states of charge of the storage modules, so this storage module is usually charged with a current of high potential. Therefore, the lifespan of the battery or battery pack would be shortened, and even a danger may occur easily.

### SUMMARY

According to one or more embodiments, a rechargeable battery includes power storage modules, a charging module and a control module. The charging module is electrically connected to the power storage modules, and the control module is electrically connected to the charging module and the power storage modules. The charging module selectively charges the power storage modules through charging paths, each of which corresponds to one of the power storage modules. The control module commands the charging module to charge at least one of the power storage modules according to the state of charge (SoC) indicator of each of the power storage modules.

According to one or more embodiments of the disclosure, a charging method includes the following steps. First, the SoC of each of the power storage modules is acquired. Then, at least one of the power storage modules is charged through one of charging paths according to the SoC of each of the power storage modules. Each of the power storage modules corresponds to different one of the charging paths.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a rechargeable battery according to an embodiment of the disclosure;

FIG. 2 is a block diagram of a rechargeable battery according to another embodiment of the disclosure;

FIG. 3 is a block diagram of a rechargeable battery according to yet another embodiment of the disclosure;

FIG. 4 is a flow chart of a charging method according to an embodiment of the disclosure; and

FIG. 5A and FIG. 5B are flow charts of a charging method according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

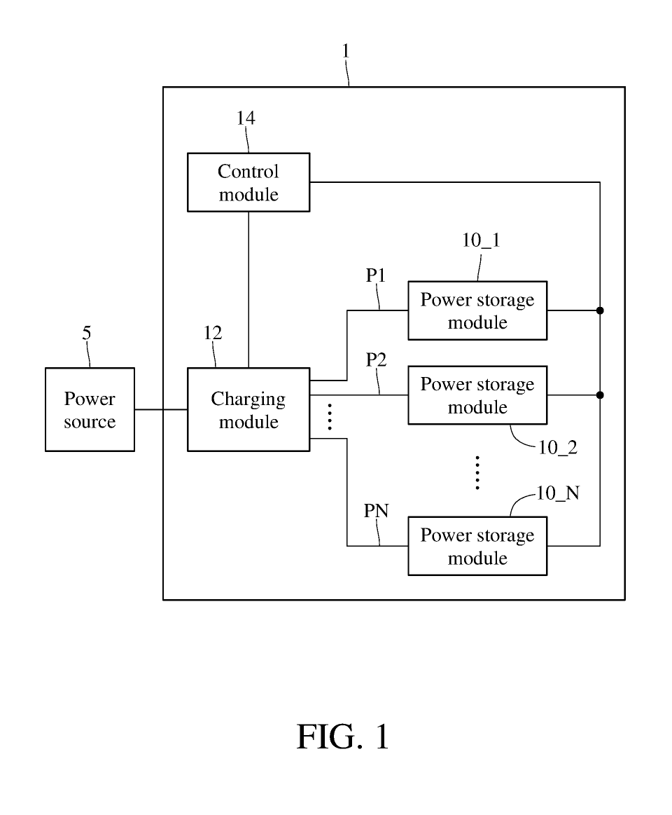

Please refer to FIG. 1. FIG. 1 is a block diagram of a rechargeable battery according to an embodiment of the disclosure. The disclosure provides a rechargeable battery 1, and the rechargeable battery 1 includes power storage modules 10_1˜10_N, a charging module 12 and a control module 14, wherein N is a positive integer larger than 1. The charging module 12 is electrically connected to the power storage modules 10_1˜10_N. The control module 14 is electrically connected to the charging module 12 and the power storage modules 10_1˜10_N.

The power storage modules 10_1˜10_N are used to store electricity. When the battery 1 is electrically connected to an external electronic device (not shown in FIG. 1) whose specification conforms to the specification of the battery 1, the battery 1, via the power storage modules 10_1˜10_N, powers the external electronic device. Herein the disclosure is not limited to the specification of each power storage module, such as the model, battery capacity or output voltage. In an embodiment, each of the power storage modules 10_1˜10_N includes a processing unit and a communication unit. The processing unit determines the states of charge of the power storage modules 10_1˜10_N, and the communication unit sends the determinations to devices or modules except the power storage modules 10_1˜10_N for relevant analysis and processing. The processing unit and the communication unit are, for example, respective integrated circuits (ICs) or integrated into the same IC. For example, the communication unit wirelessly or wiredly sends the relevant data to devices or modules except the power storage modules 10_1˜10_N. The above description is only for exemplary implementations, and the disclosure is not limited to these exemplary implementations.

The charging module 12 is used to selectively charge one or more of the power storage modules 10_1˜10_N through the charging paths P1˜PN. The power storage modules 10_1˜10_N respectively correspond to different charging paths P1˜PN. Specifically, the power storage module 10_1 corresponds to the charging path P1, the power storage module 10_2 corresponds to the charging path P2, and the others can be deduced by analogy and will not be described hereinafter. The charging path P1 is different from the charging path P2. In an embodiment, the charging module 12 has different charging ports that are electrically connected to the power storage modules 10_1˜10_N one to one, so as to prevent the charging paths P1˜PN from being electrically connected to each other.

The control module 14 is used to command the charging module 12 to charge at least one of the power storage modules 10_1˜10_N according to the SoC indicator of the power storage modules 10_1˜10_N. In an embodiment, the control module 14 commands the charging module 12 to charge one or more power storage modules with the lowest SoC among the power storage modules 10_1˜10_N. In details, for example, the control module 14, according to the SoC of each of the power storage modules 10_1˜10_N, searches out which power storage module has the lowest SoC among the power storage modules 10_1˜10_N. In another embodiment, for example, the control module 14 searches out which one of the power storage modules has the lowest SoC according to the SoC of one or more typical power storage modules among the power storage modules 10_1˜10_N. In other words, in this embodiment, the control module 14 determines the SoC of M power storage modules among the power storage modules 10_1˜10_N, and M is a positive integer larger than 1 but smaller than or equal to N. For example, the control module 14 is a micro control unit (MCU). Although the following description is based on that the control module 14 determines the states of charge of all of the power storage modules 10_1˜10_N, the disclosure neither is limited to the amount of power storage modules used by the control module 14 to search out one or more power storage modules with the lowest SoC, nor is limited to the manner used by the control module 14 to determine and calculate the SoC.

In an operational situation of charging the rechargeable battery 1, a user electrically connects the rechargeable battery 1 to the power source 5 for charging the battery 1. For example, such a power source 5 is supply mains. Herein, the electric connection manner between the battery 1 and the power source 5 and the type of the power source 5 are not limited herein. It is assumed that the power storage module 10_1 has the lowest SoC, and in this case, the control module 14 commands the charging module 12 according to the above determination to use the electricity provided by the power source 5 to charge the power storage module 10_1. When the SoC of the power storage module 10_1 is charged up to a SoC threshold, the control module 14 searches at least one present power storage module with the lowest SoC and a new SoC threshold for the repeat of the foregoing charging process. The above searching process at the first time can be done before or after the battery 1 is connected to the power source 5.

In an embodiment, the SoC threshold is, for example, the second lowest SoC among the power storage modules 10_1˜10_N. Assume that the power storage module 10_2 has the second lowest SoC, and when the control module 14 learns about that the SoC of the power storage module 10_1 is charged to be similar to the SoC of the power storage module 10_2, the control module 14 would further command the charging module 12 to simultaneously charge the power storage module 10_1 and the power storage module 10_2. The so-called similar SoC is that the difference between the SoC of the power storage module 10_1 and the SoC of the power storage module 10_2 is substantially equal to or less than a preset threshold. In other words, the SoC of the power storage module 10_1 herein is smaller than, substantially equal to or larger than the SoC of the power storage module 10_2. The preset threshold can freely be designed according to a variety of practical requirements by a person of ordinary skill in the art, and the disclosure has no limitation thereon.

In practice, the control module 14 can circularly and repeatedly search for one or more power storage modules with the lowest SoC among the power storage modules 10_1˜10_N, and the one or more power storage modules with the lowest SoC are subjected to the above charging process. Particularly, the present power storage module with the lowest SoC is defined as, for example, a first power storage module, and the present power storage module is defined as, for example, a second power storage module, and the control module uses the SoC of the second power storage module as a present SoC threshold. When the SoC of the first power storage module is charged to a SoC similar to the present SoC threshold, the present second power storage module is redefined as another first power storage module, so the amount of present first power storage modules increases. The control module 14 further selects one or more power storage modules among the power storage modules 10_1˜10_N except the present first power storage modules to define the one or more selected power storage modules as one or more new second power storage modules, and then sets the SoC of the one or more new second power storage modules as a new SoC threshold, and the one or more present first power storage modules, the one or more present second power storage modules and the present SoC threshold are subjected to the above steps. In an embodiment, when the amount of first power storage modules is up to a preset value, the control module 14 will directly charge all the power storage modules together instead of repeating the above circular process. In another embodiment, when a ratio of the amount of first power storage modules to the amount of all power storage modules is up to a preset ratio, the control module 14 will directly charge all the power storage modules together instead of repeating the above circular process. Therefore, it may be assured that at least a part of power storage modules in the battery 1 has similar states of charge, so as to prevent that a certain power storage module always has the lowest SoC.

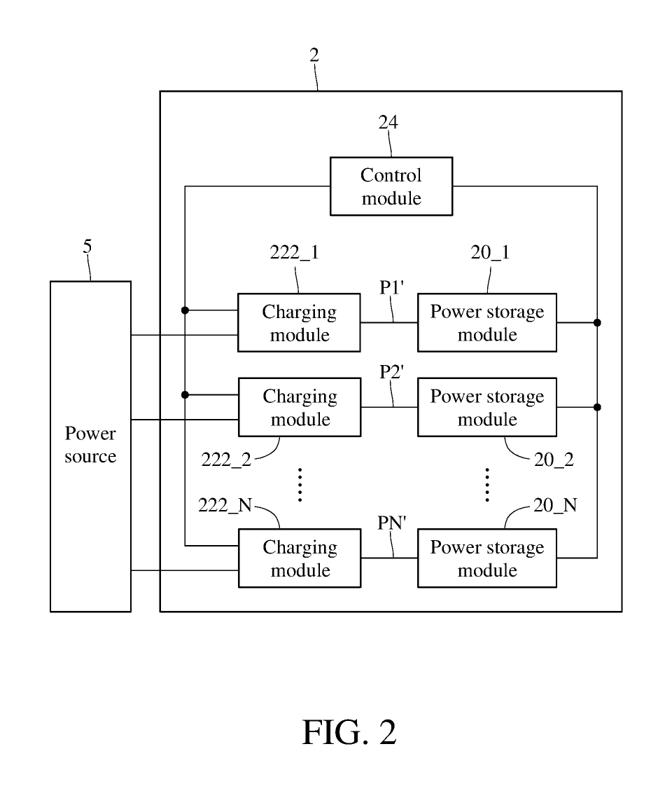

Please refer to FIG. 2. FIG. 2 is a block diagram of a rechargeable battery according to another embodiment of the disclosure. Different from the embodiment in FIG. 1, a charging module 22 in a battery 2 in the embodiment in FIG. 2 includes charging units 222_1˜222_N. The charging units 222_1˜222_N are electrically connected to power storage modules 20_1˜20_N, respectively. Particularly, the charging unit 222_1 is electrically connected to the power storage module 20_1, the charging unit 222_2 is electrically connected to the power storage module 20_2, and the others can be deduced by analogy and will not be described herein. The charging units 222_1˜222_N are used to selectively charge the power storage modules 20_1˜20_N through charging paths P1′˜PN′. Each of the charging units 222_1˜222_N corresponds to one of the charging paths P1′˜PN′. In this embodiment, the charging unit 222_1 is used to charge the power storage module 20_1 through the charging path P1′, the charging unit 222_2 is used to charge the power storage module 20_2 through the charging path P2′, and the others can be deduced by analogy and will not be described hereafter. The charging units 222_1˜222_N are not limited to be the same or different.

The control module 24 commands at least one of the charging units 222_1˜222_N to charge the power storage modules 20_1˜20_N electrically connected thereto according to the states of charge of the power storage modules 20_1˜20_N. Specifically, the control module 24 searches out at least one power storage module with the lowest SoC among the power storage modules 20_1˜20_N and commands at least one charging unit corresponding to the at least one power storage module with the lowest SoC to charge the at least one power storage module with the lowest SoC. The searching manner can be referred to the explanation of the control module 14, and however, a slight difference between the control module 14 and the control module 24 is that the control module 24 commands at least one of the charging units 222_1˜222_N according to the states of charge of the power storage modules 20_1˜20_N to charge at least one of the power storage modules 20_1˜20_N respectively electrically connected to the charging units 222_1˜222_N.

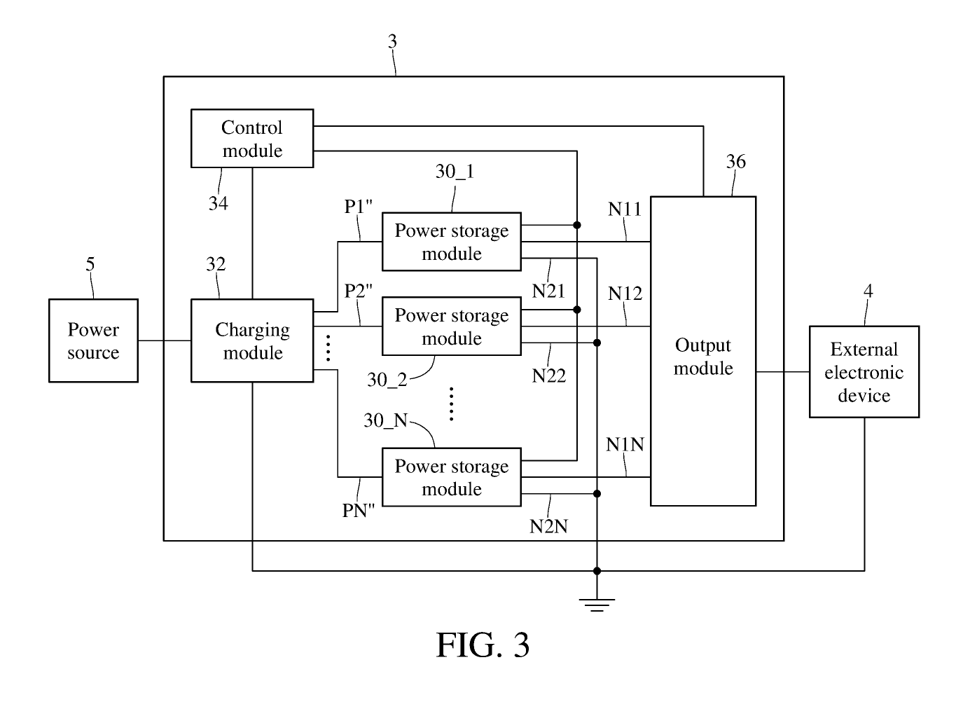

Please refer to FIG. 3. FIG. 3 is a block diagram of a rechargeable battery according to yet another embodiment of the disclosure. Different from the embodiment in FIG. 1, a battery 3 in the embodiment in FIG. 3 further includes an output module 36 that is electrically connected to electricity storage units 30_1˜30_N. When the battery 3 is electrically connected to an external electronic device 4, the electricity storage units 30_1˜30_N power the external electronic device 4 through the output module 36. In this embodiment, the electricity storage units 30_1˜30_N are connected to the same ground end, and the output module 36 includes a bus for selectively electrically connected to the electricity storage units 30_1˜30_N.

Specifically, each of the electricity storage units 30_1˜30_N has, for example, a first transmission end and a second transmission end to transmit DC power, and the first transmission end and the second transmission end are, for example, the positive and negative ends of the DC power source. More particularly, the electricity storage unit 30_1 has a first transmission end N11 and a second transmission end N21, the electricity storage unit 30_2 has a first transmission end N12 and a second transmission end N22, and the others can be deduced by analogy and will not be described hereafter. When the battery 3 is electrically connected to the external electronic device 4 to power the external electronic device 4, the control module 34 commands the output module 36 to couple to at least a part of the first transmission ends of the electricity storage units 30_1˜30_N through its bus, and the control module 34 also commands the charging module 32 not to charge the electricity storage units 30_1˜30_N. In this embodiment, the second transmission ends of the electricity storage units 30_1˜30_N are coupled to the same ground end so that at least a part of the electricity storage units 30_1˜30_N is connected in parallel. The battery 3 powers the external electronic device 4 via the parallel-connected electricity storage units. When the battery 3 is charged by the power source 5, the control module 34 commands the output module 36 not to couple to the first transmission ends of the electricity storage units 30_1˜30_N via the bus, so the electricity storage units 30_1˜30_N as described above are charged through different current paths. In an embodiment, for the power storage modules 30_1˜30_N, the first transmission ends N11˜N1N are coupled to the charging paths P1˜PN, respectively. Particularly, the charging path P1 is coupled to the first transmission end N11, the charging path P2 is coupled to the first transmission end N12, and the others can be deduced by analogy and no more description hereafter.

In addition, in the embodiment in FIG. 3, the control module 34 can be electrically connected to the external electronic device 4. Also, the control module 34 can further provide the information about the power storage modules 30_1˜30_N to the external electronic device 4. The information about the power storage module is, for example, the specification, current SoC or other information of the power storage module. It is optional for the control module 34 to provide the external electronic device 4 with information, and the disclosure is not limited thereto.

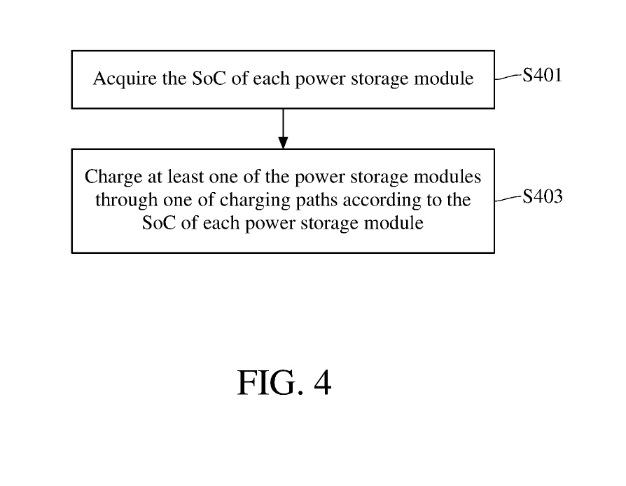

Based on the above concept, the disclosure further provides a charging method. Please refer to FIG. 4 to explain the charging method. FIG. 4 is a flow chart of a charging method according to an embodiment of the disclosure. In step S401, the SoC of each of the power storage modules is obtained. In step S403, one of charging paths is used to charge at least one of the power storage modules according to the SoC of each of the power storage modules. Each of the power storage modules corresponds to different one of the charging paths. In an embodiment, obtaining the SoC of each power storage module includes searching out at least one first power storage module with the lowest SoC among the power storage modules and charging the at least one first power storage module. In another embodiment, the charging method further includes searching out at least one second power storage module with the second lowest SoC among the power storage modules. When the SoC of the at least one first power storage module is charged to be not smaller than a SoC threshold, the at least one first power storage module and the at least one second power storage module are charged. The SoC threshold is, for example, substantially equal to the SoC of at least one second power storage module.

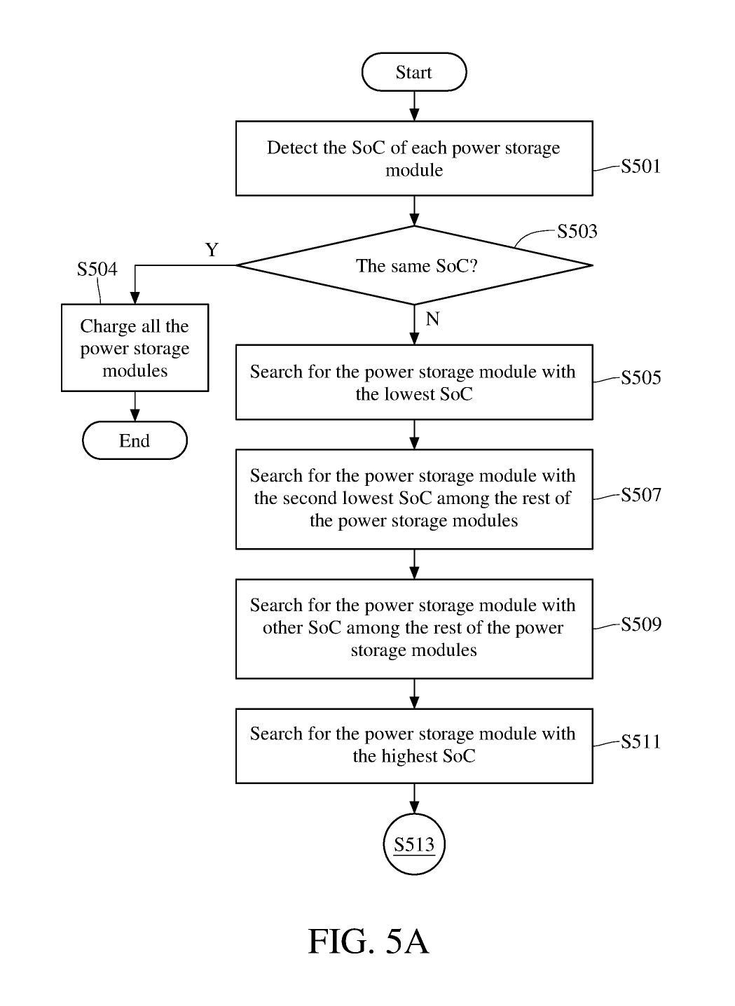

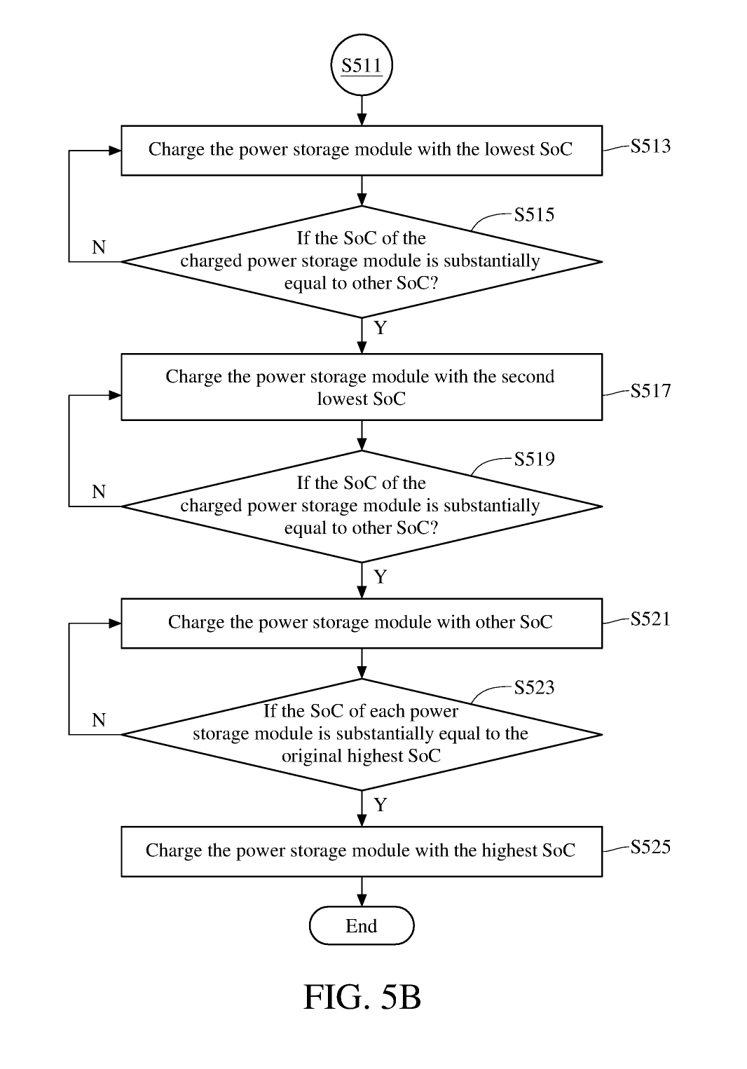

Please refer to FIGS. 1, 5A and 5B to illustrate a particular embodiment of the disclosure. FIG. 5A and FIG. 5B are flow charts of a charging method according to another embodiment of the disclosure. For a concise description, this embodiment assumes that N is 5 and the states of charge of the power storage modules 10_1˜10_5 are different from each other; and for example, in the beginning, the SoC of the power storage module 10_1 is the lowest, the SoC of the power storage module 10_2 is the second lowest, the states of charge of the power storage modules 10_3 and 10_4 are higher than the SoC of the power storage module 10_2, and the SoC of the power storage module 10_5 is the highest.

In the embodiment shown in FIG. 5A and FIG. 5B, the states of charge of the power storage modules 10_1˜10_5 are detected in step S501. In step S503, it is done to determine whether the states of charge of the power storage modules 10_1˜10_5 are the same. If yes, the process proceeds to step S504, where the power storage modules 10_1˜10_5 are charged until charging all the power storage modules 10_1˜10_5 is complete or the power source 5 is removed. If not, the process proceeds to step S505, to search for the power storage module with the lowest SoC, i.e. the power storage module 10_1. Then, in step S507, the power storage module with the second lowest SoC, i.e. the power storage module 10_2, is found among the power storage modules except the power storage module 10_1. Also, in step S509, one or more power storage modules of other one or more states of charge are found among the power storage modules except the power storage modules 10_1 and 10_2. In this embodiment, the other one or more states of charge are, for example, one or more states of charge higher than the second lowest SoC but lower than the highest SoC, and the power storage modules of other one or more states of charge are, for example, the power storage modules 10_3 and 10_4. In another embodiment, the SoC of the power storage module 10_3 and the SoC of the power storage module 10_4 are sorted, and it can be learn that the SoC of the power storage module 10_3 is lower than the SoC of the power storage module 10_4. In step S511, the power storage module with the highest SoC, i.e. the power storage module 10_5, is searched out.

Then, in step S513, the power storage module with the lowest SoC, i.e. the power storage module 10_1 in this embodiment, is charged. In step S515, it is done to determine whether the SoC of the charged power storage module is substantially equal to the original second lowest SoC, i.e. the SoC of the power storage module 10_2 in the beginning. If not, step S513 will be repeated to charge the power storage module 10_1 until the SoC of the power storage module 10_1 is substantially equal to the original second SoC, so the states of charge of the power storage modules 10_1 and 10_2 are the lowest herein; and if yes, the process proceeds to step S517 to charge one or more present storage modules with the lowest SoC, i.e. the power storage modules 10_1 and 10_2, together.

In step S519, it is done to determine whether the present states of charge of the power storage modules 10_1 and 10_2 are substantially equal to the original SoC of at least one of the power storage modules 10_3 and 10_4. If not, step S517 is repeated to keep charging the power storage modules 10_1 and 10_2. If yes, the process proceeds to step S521 to charge the power storage modules 10_1 to 10_4 together. In the embodiment where the SoC of the power storage module 10_3 and the SoC of the power storage module 10_4 are sorted, the states of charge of the power storage modules 10_1, 10_2 and 10_3 are charged to a SoC similar to the SoC of the power storage module 10_4 after the SoCs of the power storage modules 10_1 and 10_2 are charged to be a SoC similar to the SoC of the power storage module 10_3. After step S521, the process proceeds to step S523 to determine whether the SoC of each power storage module is substantially equal to the original highest SoC, i.e. the SoC of the power storage module 10_5 in the beginning. If not, step S521 is repeated to charge the power storage modules 10_1 to 10_4. If yes, the process proceeds to step S525 to charge one or more present power storage modules with the highest SoC, i.e. all the power storage modules 10_1 to 10_5.

In summary, the disclosure provides a rechargeable battery and a charging method thereof, to determine the SoC of each of power storage modules and then charge at least one of the power storage modules, which has the lowest SoC. In a manner, when a first power storage module with the lowest SoC is charged to have a SoC similar to a second power storage module with the second lowest SoC, the first power storage module and the second power storage module are charged together. Therefore, it may be assured that there is more than one power storage module having a similar SoC before the charging process ends, so as to prevent the same power storage module from always having the lowest SoC. The rechargeable battery and the charging method thereof in the disclosure may consider each power storage module to avoid always charging the same power storage module by a high current, so as to maintain the inherent lifespan of a battery. Therefore, the disclosure may have relatively high practicability.

What is claimed is:

1. A rechargeable battery, comprising:
power storage modules;
a charging module electrically connected to the power storage modules and configured to selectively charge the power storage modules through charging paths, each of which corresponds to one of the power storage modules, when electrically connected to a power source; and
a control module electrically connected to the charging module and the power storage modules and configured to command the charging module to charge at least one of the power storage modules according to a state of charge (SoC) indicator of each of the power storage modules.

2. The battery according to claim 1, wherein the control module commands the charging module to charge at least one of the power storage modules, which has the lowest SoC.

3. The battery according to claim 1, wherein the charging module comprises charging units, each of which is electrically connected to one of the power storage modules and corresponds to one of the charging paths, the charging units are configured to selectively charge the power storage modules through one or more of the charging paths, and the control module commands at least one of the charging units to charge the power storage module electrically connected to the at least one charging unit according to the SoC indicators of the power storage modules.

4. The battery according to claim 3, wherein the control module searches out at least one of the power storage modules, which has the lowest SoC, and commands at least related one of the charging units to charge the at least one power storage module with the lowest SoC.

5. The battery according to claim 1, further comprising:
an output module electrically connected to the power storage modules, and the power storage modules powering an external electronic device through the output module when the battery is electrically connected to the external electronic device.

6. The battery according to claim 5, wherein when the power storage modules power the external electronic device through the output module, the charging module stops charging the power storage modules.

7. A charging method for a battery that comprises power storage modules, and the charging method comprising:
acquiring a SoC of each of the power storage modules; and
charging at least one of the power storage modules through one of charging paths according to the SoC of each of the power storage modules;
wherein each of the power storage modules corresponds to different one of the charging paths.

8. The charging method according to claim 7, wherein acquiring the SoC of each of the power storage modules comprises:
searching out at least one first power storage module with the lowest SoC among the power storage modules; and
charging the at least one first power storage module.

9. The charging method according to claim 8, further comprising:
searching out at least one second power storage module with the second lowest SoC among the power storage modules; and
simultaneously charging the at least one first power storage module and the least one second power storage module when the SoC of the at least one first power storage module is charged up to not smaller than a SoC threshold.

10. The charging method according to claim 9, wherein the SoC threshold is the SoC of the least one second power storage module.
